(19) United States
(12) Patent Application Publication
(10) Pub. No.: US 2026/0105847 A1
(43) Pub. Date: Apr. 16, 2026

(54) FLIGHT PLAN TRANSFORMATION FOR DATA TRANSMISSION

(71) Applicant: Honeywell International Inc., Charlotte, NC (US)

(72) Inventors: Ravikumar Selvarajan, Madurai (IN); Sreenivasan K. Govindillam, Bengaluru (IN)

(21) Appl. No.: 18/917,817

(22) Filed: Oct. 16, 2024

(51) Int. Cl. G08G 5/00; H04L 67/02

(52) U.S. Cl. CPC G08G 5/34; G08G 5/26; H04L 67/02

(57) ABSTRACT

A device for communicating a flight plan for an aircraft may include transceiver circuitry; a memory configured to store an active flight plan and a transformed flight plan that is different than the active flight plan; and processing circuitry configured to: in response to receiving an update to the active flight plan, make the update to the active flight plan and make a corresponding update to the transformed flight plan based on a transform scheme that transforms the active flight plan to the transformed flight plan; process the active flight plan in one or more applications being executed by the processing circuitry; and cause the transceiver circuitry to transmit to the second computing device a copy of the transformed flight plan.

### TECHNICAL FIELD

This disclosure relates to communication between aircraft systems.

### BACKGROUND

The avionics industry has been making technological advancements in enabling electronic flight bag (EFB) systems to obtain complex avionics data (e.g., flight plans) from avionics data systems, such as Flight Management Systems (FMSs). The EFB systems can filter and convert complex avionics data into various streaming formats (e.g., JavaScript Object Notation (JSON) or Extensible Markup Language (XML)) and transmit the converted avionics data to various client applications in the EFB systems so that applications of the EFB may utilize the data. Applications being executed by an EFB may similarly transmit data to the FMS, providing pilots with a more user-friendly manner of interacting with the FMS.

### SUMMARY

This disclosure describes a data obfuscation process that may be used for flight plan data in conjunction with, or instead of, encryption. According to techniques of this disclosure, a flight management system (FMS) may store in memory both an active flight plan and a transformed flight plan that is similar, but slightly different than, the active flight plan. The FMS may use the active flight plan for controlling the aircraft but transmit the transformed flight plan to external computing devices, such as electronic flight bags (EFBs). The FMS may modify, or encode, the active flight plan using a set of rules to generate the transformed flight plan. An authorized user of a third party device, such as an EFB, may be configured to decode the transformed flight plan to generate the authorized, or actual, flight plan. Thus, authorized uses may obtain the actual flight plan from the FMS. Should an unauthorized user intercept the flight plan, however, the unauthorized user would obtain a copy of the transformed flight plan, which appears to be a genuine flight plan that is being flown by the FMS but in actuality is altered.

According to one example, a computer-implemented method for communicating a flight plan from avionics of an aircraft to a computing device includes: storing, in a memory of the avionics, an active flight plan; storing, in the memory of the avionics, a transformed flight plan that is different than the active flight plan; in response to receiving an update to the active flight plan: making the update to the active flight plan; and making a corresponding update to the transformed flight plan based on a transform scheme that transforms the active flight plan to the transformed flight plan; controlling, by processing circuitry of the avionics, a flight management system based on the active flight plan, wherein the flight management system controls an aircraft to follow a flight path defined by the active flight plan; and transmitting to the computing device a copy of the transformed flight plan.

According to another example, a first device for communicating a flight plan for an aircraft to a second device comprises transceiver circuitry; a memory configured to store an active flight plan and a transformed flight plan that is different than the active flight plan; and processing circuitry configured to: in response to receiving an update to the active flight plan: make the update to the active flight plan; and make a corresponding update to the transformed flight plan based on a transform scheme that transforms the active flight plan to the transformed flight plan; process the active flight plan in one or more applications being executed by the processing circuitry; and cause the transceiver circuitry to transmit to the second computing device a copy of the transformed flight plan.

The details of one or more examples are set forth in the accompanying drawings and the description below. Other features, objects, and advantages will be apparent from the description, drawings, and claims.

### BRIEF DESCRIPTION OF DRAWINGS

FIG. 1 shows an overview of an example computing environment in which techniques of the present disclosure may be implemented.

FIG. 2 shows a system for performing flight plan obfuscation in accordance with techniques of this disclosure.

FIG. 3A is a flow diagram illustrating a process for managing and transferring a flight plan in accordance with the techniques of this disclosure.

FIG. 3B is a flow diagram illustrating a process for receiving flight plan data in accordance with the techniques of this disclosure.

FIG. 4 shows an example of a gateway device for facilitating communication between an avionics system and a computing device for executing EFB applications in accordance with techniques of this disclosure.

FIG. 5 shows an example of a computing device for executing EFB applications in accordance with techniques of this disclosure.

FIG. 6 shows an example of an avionics system in accordance with techniques of this disclosure.

Throughout the figures, like reference numerals across multiple figures refer to the same hardware, software, data, step, etc.

### DETAILED DESCRIPTION

The avionics of modern aircraft often include a flight management system (FMS) that can generate a flight plan and navigate an aircraft through the flight plan. A flight plan may, for example, include a departure location, destination location, a departure time, a desired arrival time, a desired flight duration, a desired altitude, a set of waypoints, an identification of weather structures to be avoided, a fuel load for the aircraft, a number of passengers on the aircraft, a desired speed, an identification of a runway, or other such flight-related information. Based on feedback from various navigation sensors on the aircraft, the FMS may ensure that the aircraft is adhering to the flight plan. In this regard, an FMS may be viewed as the custodian of the flight plan.

An electronic flight bag (EFB) is a computing device used by pilots to review operating manuals, airport diagrams, navigational charts, and other types of reference materials that were previously paper-based. More advanced applications for interacting with an FMS and other aspects of an aircraft's avionics are being added to EFBs. With the advent of data connectivity between FMSs and EFBs, flight plans may be sent back and forth between FMSs and EFBs. For example, an FMS may generate a flight plan and supply the flight plan to an EFB for a variety of purposes such as data analytics, visualization, flight plan optimization, or the like. In other examples, an EFB may generate the flight plan and transmit, e.g., upload, the flight plan to an FMS for the FMS to execute the uploaded flight plan. This EFB-FMS connectivity brings value to the airlines and pilots in terms of situational awareness, flight efficiency, fuel efficiency, and predictive maintenance, among other benefits, which can increase revenue and improve safety.

This EFB-FMS connectivity also potentially presents an entry point for incorrect or corrupted data caused by a malfunction. The EFB-FMS connectivity may also present a security vulnerability that could be exploited by a nefarious actor. For example, a hacker could use confidential real-time flight plan information for commercial exploitation or, potentially even worse, to disrupt a flight or bring down a plane. To avoid such an event, existing FMS systems may encrypt flight plans before transmitting, but encryption may be breached, particularly if the encryption is weak, which is often the case for older FMSs that do not have significant processing power or hardware resources.

This disclosure describes a data obfuscation process that may be used in conjunction with, or instead of, encryption. According to techniques of this disclosure, an FMS may store in memory both an active flight plan and a transformed flight plan that is similar, but slightly different than, the active flight plan. The FMS may use the active flight plan for controlling the aircraft but transmit the transformed flight plan to external computing devices, such as EFBs. The FMS may modify, or encode, the active flight plan using a set of rules to generate the transformed flight plan. An authorized user of a third party device, such as an EFB, may be configured to decode the transformed flight plan to generate the authorized, or actual, flight plan. Thus, authorized uses may obtain the active, or actual, flight plan from the FMS. Should an unauthorized user intercept the flight plan, however, the unauthorized user would obtain a copy of the transformed flight plan, which appears to be a genuine flight plan that will be flown, is being flown, or was flown, by the FMS but in actuality is altered.

Throughout this disclosure, an actual or active flight plan generally refers to a flight plan that is to be used, is being used, or was used by an FMS to control an aircraft. In contrast, a transformed flight plan refers to a flight plan that would be capable of being used by an FMS to control an aircraft but is never actually used, in its transformed form, to control the aircraft.

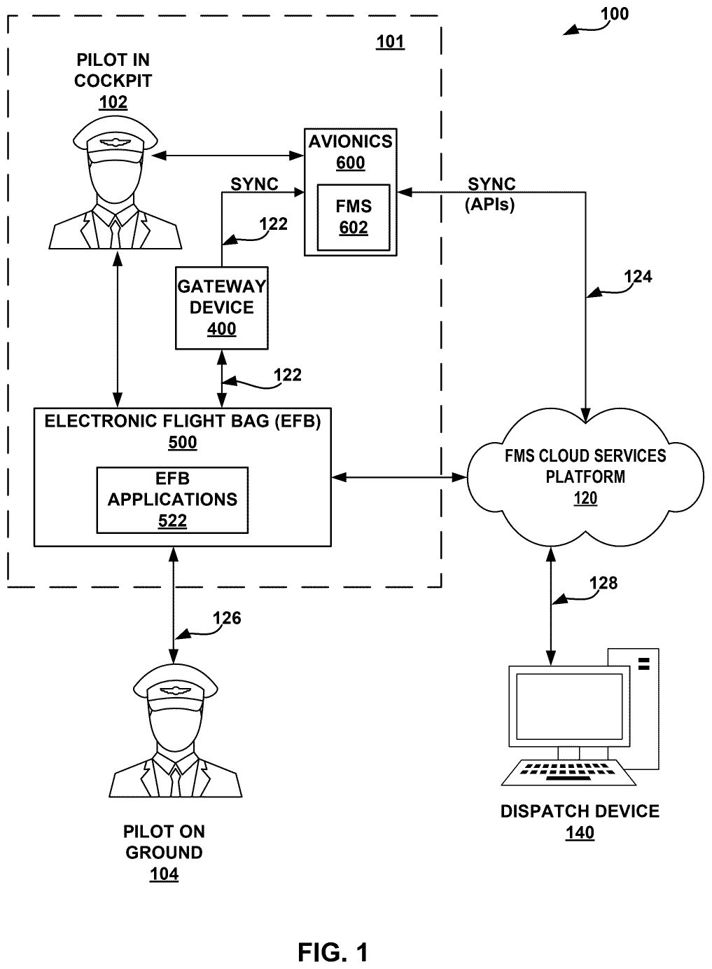

FIG. 1 shows an overview of an example computing environment 100, according to one or more examples of the present disclosure. In environment 100, gateway device 400 is configured to facilitate communication between EFB 500 and avionics 600. Gateway device 400, EFB 500, and avionics 600 are all devices or systems that may be located inside aircraft 101. Environment 100 also includes a connected FMS cloud services platform 120 (platform 120) and a dispatcher device 140, which may be located outsider of aircraft 101. EFB 500 may be a computer device carried by a pilot or a flight crew, which may store, for example, navigational charts, maps for air and ground operations of an aircraft, a flight plan management system, an aircraft operating manual, flight-crew operating manual, software applications which automate flight-related or avionics-related computation tasks, and/or any application or data which may be installed in a general purpose computing platform. EFB 500 may include a pilot information display (PID).

Avionics 600 generally represents any electronic systems that may be implemented in an aircraft. Avionics 600 may, for example, perform functions related to communication, navigation, safety monitoring, and other such functionality. Avionics 600 includes FMS 602, which represents a specialized computer system configured to automate in-flight tasks according to a flight plan. Dispatcher device 140 may be any computer device which may be accessed by a user who performs planning, flying, navigating, or managing tasks associated with aircraft, airspaces, airports, or flight plans. Accordingly, the user is not limited to a dispatcher, and the dispatcher device 140 is not limited to a device of a dispatcher. The connected FMS cloud services platform 120 may be a cloud-based platform that provides FMS services to any user who has authorized access to the platform.

As shown in FIG. 1, the environment 100 may accommodate access by various types of users. For example, a pilot 102, who may be in cockpit, may have access to EFB 500 and EFB applications 522 installed on EFB 500. Pilot 102 may also have access to avionics 600 and FMS 602, through which pilot 102 may access the connected FMS cloud services platform 120. EFB applications 522 may access connected FMS cloud services platform 120 and provide the FMS services to the users of EFB 500 in which the EFB applications 522 are installed. In that way, EFB 500 may provide to pilot 102 user-friendly and customized user interfaces, by which pilot 102 may interact with FMS services from the platform 120.

FMS 602 may also be configured to synchronize data 124 with connected FMS cloud services platform 120, using, for example, an application programming interface (API). In addition, FMS 602 may also be configured to synchronize data 122 with EFB applications 522 via gateway device 400. Thus, in some implementations, FMS 602 may be synchronized with data from both EFB 500 and platform 120 in real-time or at predetermined intervals, in such a way that the pilot 102 may rely on the on-board FMS 602 for all tasks arising in the environment 100. As will be described in more detail below, this synchronization process may include synchronizing an active flight plan between FMS 602, FMS cloud services platform 120, and EFB 500 by including a transformed flight plan, rather than the active flight plan, in data 122 and data 124.

A pilot 104, who may be on the ground, may also access EFB 500 and the EFB applications 522. In some implementations, the pilot 104 and the pilot on cockpit 102 may be the same pilot, yet under different circumstances (e.g., time and location of the access). Additionally, or alternatively, the pilot 104 may be a different pilot, or another authorized member of the flight crew, who accesses EFB 500 on the ground for an official duty related to the connected FMS cloud services platform 120. While pilot 104 is accessing the EFB applications 522 via EFB 500, the EFB applications 522 may access the connected FMS cloud services platform 120 to receive various FMS services. In that way, EFB 500 may provide user-friendly and customized user interfaces, by which FMS services 126 from the connected FMS cloud services platform 120 may be serviced to pilot 104.

A dispatcher or other user may also access the connected FMS cloud services platform 120 through a dispatcher device 140. A dispatcher, in accordance with the present disclosure, may be any authorized personnel performing duties related to dispatching of aircraft in the environment 100. For example, a dispatcher may be an airline staff, an airport staff, air traffic control personnel, a ground control personnel, a member of a relevant aviation authority, or any other authorized person who may benefit from FMS services from the connected FMS cloud services platform 120 in performing their duties. Dispatcher device 140 may be any computing device capable of establishing a connection 128 to the cloud and interfacing with the connected FMS cloud services platform 120. While the dispatcher is accessing the FMS services via the dispatcher device 140, the dispatcher device 140 may access the connected FMS cloud services platform 120 to receive various FMS services. In that way, the dispatcher device 140 may provide user-friendly and customized user interfaces, by which FMS services from the connected FMS cloud services platform 120 may be serviced to the dispatcher.

FMS 602, EFB 500, and dispatcher device 140 may include one or more devices capable of receiving, generating, storing, processing, and/or providing information associated with FMS services. For example, FMS 602, EFB 500, or the dispatcher device 140 may include a communication and/or computing device, such as a mobile phone (e.g., a smart phone, a radiotelephone, etc.), a computer (e.g., a desktop computer, a laptop computer, a tablet computer, a handheld computer), a gaming device, a wearable communication device (e.g., a smart wristwatch, a pair of smart eyeglasses, etc.), or a similar type of device.

As part of facilitating communication between any of avionics 600, EFB 500, or FMS cloud services platform 120, the systems and devices may be configured to transmit and receive flight plans in the form of a .RTE (route) file, a .FPL file, or other file formats. As will be explained in more detail below, avionics 600, EFB 500, or FMS cloud services platform 120 may be configured to transmit and receive .RTE and .FPL files with some values obfuscated values rather than transmitting and receiving actual flight plans.

A .RTE file is a standard file format that may be used by FMS 602 and EFB applications 522 to store and exchange flight planning data. As will be illustrated in more detail below, .RTE files include some or all of sections for flight information, route details, altitude and speed information, fuel information, performance data, weather information, and other notes or remarks of interest to a pilot or other user. Each section then includes a field name and a value for the field name. A non-exhaustive list of fields that may be included in a .RTE file are FLIGHT_NUMBER, AIRCRAFT_TYPE, DEPARTURE_AIRPORT, DESTINATION_AIRPORT, ESTIMATED_DEPARTURE_TIME, ESTIMATED_ARRIVAL_TIME, WAYPOINTS, AIRWAYS, DEPARTURE_PROCEDURE, ARRIVAL_PROCEDURE, CRUISING_ALTITUDE, CLIMB_PROFILE, DESCENT_PROFILE, TOTAL_FUEL, TRIP_FUEL, RESERVE_FUEL, TAKEOFF_WEIGHT, LANDING_WEIGHT, ZERO_FUEL_WEIGHT, DEPARTURE_WEATHER, ARRIVAL_WEATHER, ENROUTE_WEATHER, PILOT_REMARKS, OPERATIONAL_NOTES.

Pilots (e.g., pilots 102 and 104) and dispatcher (e.g., a user of dispatch device 140) may may use .RTE files to plan and file flight routes and ensure compliance with air traffic control and safety regulations. A .RTE file may be uploaded from EFB 500 to FMS 602 to provide necessary flight details for navigation and management during the flight. The interoperability of .RTE files may facilitate sharing of flight plans between different systems and stakeholders (e.g., airlines, airports, air traffic control). Instead of or in addition to .RTE files, FMS 602 and EFB applications 522 may exchange .FPL (flight plan) files, which include similar information as .RTE files and are used for similar purposes as .RTE files, but have a different formatting.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1. Furthermore, two or more devices shown in FIG. 1 (e.g., EFB 500 and dispatcher device 140) may be implemented within a single device, or a single device shown in FIG. 1 (e.g., EFB 500, FMS 602, or dispatcher device 140) may be implemented as multiple, distributed devices. Additionally, or alternatively, a set of devices (e.g., one or more devices) of environment 100 may perform one or more functions described as being performed by another set of devices of environment 100.

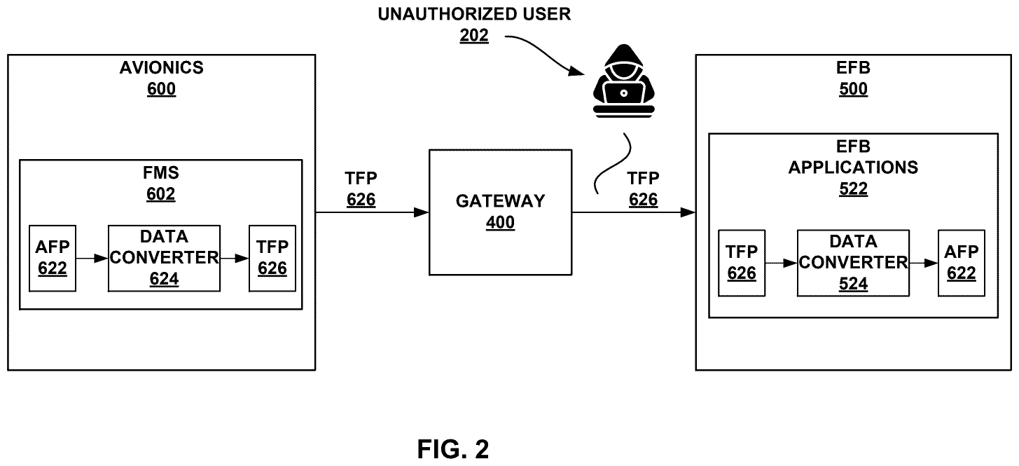

FIG. 2 shows a system for performing flight plan obfuscation in accordance with techniques of this disclosure. In the example of FIG. 2, gateway device 400 manages data communication between EFB 500 and avionics 600. EFB 500 may be configured to communicate with gateway device 400 using widely available communication protocols and infrastructure, such as a hypertext transfer protocol (HTTP) connection over WiFi. Gateway device 400 and avionics 600 may be configured to communicate using restricted protocols and infrastructure such as Aeronautical Radio, Incorporated (ARINC) standardized protocols and hardware. The techniques of this disclosure, however, do not necessarily require a gateway device such as gateway device 400.

Avionics 600 includes FMS 602. FMS 602 is configured to store both an active flight plan 622 and a transformed flight plan 626. Active flight plan 622 and transformed flight plan 626 may, for example, be two separate files, for example, in .RTE format, .FPL format, or some other format. Active flight plan 622 and transformed flight plan 626 may each be executable flight plans. That is, both active flight plan 622 and transformed flight plan 626 may be non-encrypted flight plans capable of being executed by FMS 602. Despite both active flight plan 622 and transformed flight plan 626 being executable, FMS 602 only uses active flight plan 622 to control an aircraft. Transformed flight plan 626 is intended to look real, i.e., be executable, even though FMS 602 does not use transformed flight plan 626 to control the aircraft.

In response to receiving an update to active flight plan 622, for example from a pilot, FMS 602 may be configured to make a corresponding update to transformed flight plan 626 using data converter 624. Data converter 624 may generate a transformed flight plan from an active flight plan using a transform scheme selected from a plurality of available transform schemes. Each transform scheme may define a set of rules, algorithms, processes, etc. for transforming active flight plan 622 into transformed flight plan 626. By utilizing a set of different transform schemes, different communication sessions or different data exchanges use different transform schemes. Each transform scheme is reversible, meaning that whatever changes are made to active flight plan 622 to generate transformed flight plan 626 are reversible, such that transformed flight plan 626 may be transformed back, sometimes referred to as inverse transformed, into active flight plan 622. In some examples, each transform scheme may be reversible in a lossless manner, meaning that when transformed flight plan 626 is transformed back into active flight plan 622, the inverse transform process does not introduce errors due to rounding, truncation, or other such sources.

When transmitting a copy of a flight plan to EFB 500, FMS 602 may be configured to transmit a copy of transformed flight plan 626 rather than a copy of active flight plan 622. Therefore, if unauthorized user 202 were to somehow intercept a copy of the flight plan being transmitted, unauthorized user 202 would only gain access to transformed flight 626, which is not the actual active flight plan.

EFB 500 may be configured to execute an application that includes data converter 524. Data converter 524 may perform the same or reciprocal operations as data converter 624, such that EFB 500 may determine a copy of active flight plan 622 without a copy of active flight plan 622 ever being transmitted. In this regard, data converter 624 may be viewed as a data encoder, and data converter 524 may be viewed as a data decoder.

For purposes of explanation, data converter 624 and data converter 524 are being described with respect to one-way communication, i.e., data converter 624 is performing encoding and transmission and data converter 524 is performing receiving and decoding. In some implementations, however, data converter 624 and data converter 524 may be configured to engage in two-way communication. That is both data converter 624 and data converter 524 may be configured to perform both encoding and transmission as well receiving and decoding.

Data converter 624 may be configured to analyze active flight plan 622 and identify various parameters of active flight plan 622, such as distances, times, fuel required, destination region etc., and then obtain a list of flight plans that are flying to a different destination or on a different route but that otherwise closely match a significant number of parameters of active flight plan 622. This list of flight plans may either be taken from a library that includes a list of pre-generated flight plans or may be generated dynamically, using, for example, a generative artificial intelligence (AI) mechanism. From the list of flight plans identified as being close matches, data converter 624 may select one flight plan based on a user defined criterion such as a distance, destination region, or other such criteria.

Data converter 624 may then further refine and adjust the selected flight plant to make the selected flight plan closer to active flight plan 622 in terms of various aspects. For example, if the selected flight plan has three more waypoints than active flight plan 622, then data converter 624 may remove three waypoints from the selected flight plan to generate transformed flight plan 626. As another example, if the distance to a destination in the selected flight plan is 100 nautical miles more than active flight plan 622, then data converter 624 may add pseudo waypoints to increase the distance of the selected flight plan to determine transformed flight plan 626.

Data converter 624 may modify a selected flight plan by adding a certain number of redundant elements or transforming certain elements by, for example, renaming flight plan waypoints, adding flight plan waypoints, or deleting flight plan waypoints. Data converter 624 may be configured to transform active flight plan 622 using keys that represent various computational results. For instance, a flight plan made by EFB 500 may include a summary block, and the summary block may be used for transformation. If the summary block is not hacked, the received plan is transformed back to the original plan using the hash of the summary block. Examples of information included in a summary block are a fuel summary, a distance remaining, and other such information. Any value in the summary block may be used to select a transform scheme from a plurality of transform schemes. As one example, data converter 624 may support one-hundred different transform schemes with index values 0 to 99, and any value within the summary block may be input into an index generator to generate an index value used to select one of the one hundred available transform schemes. In another example, data converter 624 may implement a transform scheme based on values included in the summary. For example, if the summary block includes a distance value, then data converter 624 may determine how much to modify a way point based the first two numbers of a the distance value. For example, if the first distance value is 1800 miles, then data converter 624 may modify waypoints by 18 minutes of latitude, but if the first distance value is 1600 miles, then data converter 624 may modify way points by 16 minutes of latitude.

The hash in the summary block generally includes data that may be used for checksum or integrity verification. In some implementations of the techniques of this disclosure, additional data may also be embedded in the hash. As one example, an amount by which a way point is to be modified may be included in a hash. For example, for a hash of 5d41432abc4b2a76b9719d911017c592, the fourth and fifth numbers may correspond to the first waypoint being modified by four units of five degrees of latitude (i.e., 20 degrees of latitude). The other values in the hash may be unrelated to flight plan modification and may instead be included in the hash for purposes of error checking. In another example, another value within the hash, such as d9 in the middle of the hash, may be an index value that identifies a transform scheme from a plurality of available transform schemes. A hash is typically a long sequence of seemingly random letters and numbers that lack context, so a hash may be a useful place within a flight plan to embed information regarding the transform scheme used by data converter 624 to transform active flight plan 622 into transformed flight plan 626.

Data converter 524 may receive transformed flight plan 626 and based on values embedded in the hash, determine the transform scheme used by data converter 624 so that data converter 524 can transform transformed flight plan 626 back into active flight plan 622.

In some examples, data converter 624 may, for example, store or otherwise have access to a flight plan transformer (FPT) library that is associated with FMS 602. Data converter 624 may then analyze active flight plan 622 using parameters such as distance, time, fuel requirements, and destination region to generate a list of alternative flight plans that closely match, but are different than, active flight plan 622 based on these parameters. Data converter 624 may select a transformed flight plan 626 from this list using user-defined criteria, such as distance or destination. Data converter 624 may additionally refine transformed flight plan 626 to more resemble active flight plan 622 to ensure that transformed flight plan 626 appears legitimate to unauthorized interceptors.

The transformation and preservation algorithms implemented by data converter 624 may be configurable, such that avionics 600 and EFB 500 negotiate a transformation algorithm during a preflight phase for the duration of flight. For example, certain information may be entered by a pilot into both FMS 602 and EFB 500. As this information is the same on both devices, FMS 602 and EFB 500 may use the information to identify a common transform scheme, e.g., an encoding/decoding process, that will be known to both FMS 602 and EFB 500 but not to third parties. The algorithm may be dynamic. For a flight plan with only waypoints or positions, a fix name-based algorithm may be used. For case of trajectories, a transformation algorithm may be me made complex by, for example, altering fuel predictions and, distance to go, estimated time of arrival, or some other such parameter.

Data converter 524 may utilize known transformation criteria on transformed flight plan 626 to reverse the transformation process applied by data converter 624 and regenerate active flight plan 622, thus ensuring authorized users access to the correct data. For example, if data converter 624 added three more waypoints, then data converter 524 may identify the added waypoints and remove those three waypoints. The three waypoints that are to be removed may either be removed using a defined rule for removing waypoints or may be removed based on data embedded, e.g., hidden, in the flight plan, such as one or more values included in a hash. In some examples, data converter 524 may store or otherwise have access to a flight plan retriever (FPR) library that is associated with authorized applications of EFB applications 522. The FPR library may include the same or reciprocal information as the FPT library.

Below is an example flight plan for a flight from New York JFK airport to Los Angeles International Airport (LAX) using a .RTE style formatting. The flight plan below represents an example of active flight plan 622.

[SUMMARY]
TOTAL_WAYPOINTS: 5
CREATION_DATE: 2024-10-03
HASH: 5d41402abc4b2a76b9719d94811017c592
[FLIGHT]
ID: NYK123
DEP: JFK
ARR: LAX
DATE: 2024-10-03
TIME: 10:00
[ROUTE]
WPT1: JFK
WPT2: N32.0701 W110.5629
WPT3: N32.4911 W97.2145
WPT4: N36.0728 W86.4041
WPT5: LAX
[PERFORMANCE_DATA]
TOTAL_FUEL: 22000
TRIP_FUEL: 18000
RESERVE_FUEL: 4000
[ALTITUDE]
FL: 350
[ALTERNATES]
ALTN1: SAN
ALTN2: SFO
[NOTES]
-Departure via SID: JFKSID1
-Arrival via STAR: LAXSTAR1

In the example above, the flight information listed under [SUMMARY] is a summary of the flight plan, including a hash for error checking. The flight information, listed under [FLIGHT] includes a flight identification (ID), a departure airport (JFK), an arrival airport (LAX), a date, and time of departure. The information included under [ROUTE] lists the waypoints in the flight plan. The information under [PERFORMANCE_DATA] includes performance data, such as the total fuel, trip fuel, and reserve fuel that an aircraft may have for a flight. The information included under [ALTITUDE] indicates the cruising altitude, set at Flight Level 350 (35,000 feet) in the example above. The information listed under [ALTERNATES] specifies alternate airports in case of diversion. The information under [NOTES] lists additional instructions regarding Standard Instrument Departures (SID) and Standard Terminal Arrival Routes (STAR). It should be understood that various fields shown above are merely intended to be examples and are not an exhaustive list of all the fields that may be included in a .RTE flight plan.

As one example, to generate transformed flight plan 626 based on active flight plan 622, data converter 624 may move each intermediate waypoint 20 nautical miles north by adding 20 minutes of latitude to each intermediate waypoint. In the case of the example flight plan above, this would mean that, in transformed flight plan 626, WPT2 would have a value N32.2701 instead of N32.0701, WPT3 would have a value of N33.0911 instead of N32.4911, and WPT4 would have a value of N36.2728 instead of N36.0728. Then, upon receiving transformed flight plan 626, data converter 524 may subtract out the added 20 minutes of latitude to determine the correct latitude values for active flight plan 622. As part of transforming the waypoints, data converter 624 may, for example, confirm using information stored in a navigation database that any modification does not cause the flight plan to become noncompliant with any rules or regulations. For example, data converter 624 may be configured to perform a certain modification to the waypoints if modifying the waypoints in such a manner would cause the flight plan to include flying in restricted airspace. In some examples, the value of 20 minutes of latitude may be defined for a specific transform scheme, while in other examples the value of 20 minutes of latitude may be randomly or pseudo randomly selected based on other information included in the flight plan.

Data converter 624 may be configured to continually, i.e., in real time or near real time, update transformed flight plan 626 as updates are made to active flight plan 622. For example, if a new waypoint is added to active flight plan 622, then data converter 624 may also add a new waypoint to transformed flight plan 626, with the new waypoint being modified according to whatever transform scheme is being implemented by data converter 624. For instance, based on the example above, data converter 624 may add 20 minutes of latitude to the waypoint when adding the waypoint to transformed flight plan 626. In some instances, updating active flight plan 622 may include replacing active flight plan 622 with an updated active flight plan 622 by, for example, replacing a file used to store active flight plan 622 with a new file. In other examples, updating active flight plan 622 may include modifying a portion of active flight plan 622 to generate a new active flight plan.

In another example, to generate transformed flight plan 626 based on active flight plan 622, data converter 624 may reduce any of the fuel values by 10%. For example, data converter 624 may reduce the trip fuel value by 10% to 16200 (0.9*18000−16200), and then, to make the other information of transformed flight plan 626 internally consistent, also reduce the total fuel by the same amount, i.e., original trip fuel (18000) minus transformed trip fuel (16200) is a reduction of 1800, so data converter 624 also reduces the total fuel for active flight plan 622 by 1800 to determine a new total fuel for transformed flight plan 626, which would equal 20200. Upon receiving transformed flight plan 626, data converter 524 may perform a reciprocal process. That is, data converter 524 may determine the real trip fuel value for active flight plan 622 to be equal to 16200/0.9, which equals 18000 which corresponds to an increase of 1800. Then, data converter 524 may also increase the total fuel received in transformed flight plan 626, 20200, by 1800 to obtain the actual total fuel value of active flight plan 622, which is 22000.

In another example, to generate transformed flight plan 626 based on active flight plan 622, data converter 624 may change the arrival airport from LAX to another nearby airport, such as San Diego. When performing such a modification, active flight plan 622 may change other aspects of the flight plan, such as distances, to account for the change from LAX to San Diego. Upon receiving transformed flight plan 626, data converter 524 may perform a reciprocal process that, for the transform scheme, implemented by active flight plan 622, San Diego maps to LAX.

In some examples, data converter 624 and data converter 524 may each store copies of actual flight plans as well as transformed flight plans. Data converter 624 may map active flight plan 622 to transformed flight plan 626, and data converter 524 may map transformed flight plan 626 back to active flight plan 622.

Data converter 624 and data converter 524 may be configured to perform the same or reciprocal transformation processes. For example, data converter 624 may perform an encoding process, and data converter 524 may perform a decoding process, or vice versa. For any given flight plan, data converter 624 and data converter 524 may be configured to select from a plurality of available transform schemes. For example, eight different transform schemes may modify waypoints in eight different ways, e.g., subtract 10 minutes of latitude, subtract 20 minutes of latitude, add 10 minutes of latitude, add 20 minutes of latitude, subtract 10 minutes of longitude, subtract 20 minutes of longitude, add 10 minutes of longitude, or add 20 minutes of longitude. In some examples, a transform scheme may make different changes to different waypoints, such as add 20 minutes of latitude to even waypoints and subtract 10 minutes of longitude from odd waypoints.

The specific transform scheme of the plurality of transform schemes may be determined by data converter 624 and data converter 524 in any of a variety of manners. In some examples, data converter 624 may explicitly signal a selected transform scheme, such as in a hash in a summary block. In some examples, data converter 624 and data converter 524 may perform a common derivation technique to determine a transform scheme. In other examples, the specific information to be obfuscated may be selected by a pilot or other authorized user for a specific flight or for a specific type of flights. In other examples, the specific information to be obfuscated may be selected based on a policy known to both data converter 624 and data converter 524. For example, for flights over a certain distance or over a certain time, waypoints may be obfuscated, whereas for shorter flights times rather than waypoints are obfuscated.

In other examples, data converter 624 and data converter 524 may implicitly derive which transform scheme to use based on information known to both data converter 624 and data converter 524. For example, a field in the flight plan, such as the flight ID, may be used to generate a value that corresponds to one of the plurality of flight plans. In another example, a piece of information input into both FMS 602 and EFB applications 522 may be used to select the transform scheme. For instance, a pilot may need to enter a value, such as a fuel load or departure time, into both FMS 602 and EFB applications 522, and that information may be used to select the transform scheme. Generally speaking, any value known to both FMS 602 and EFB applications 522 may be used to select the transform scheme. Introducing some randomness or pseudo randomness into the selection of the transform scheme makes it more difficult for an attacker or interceptor to decipher the transform scheme being used.

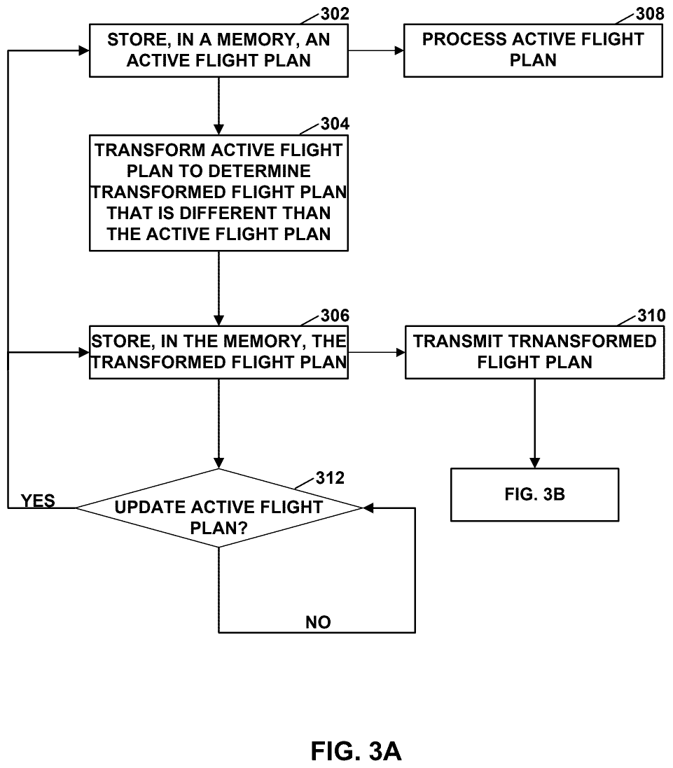

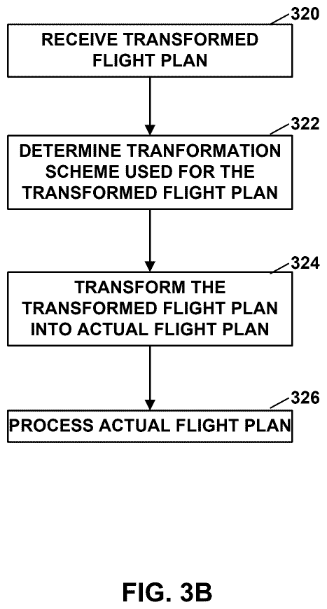

FIG. 3A is a flow diagram illustrating a data transfer process in accordance with the techniques of this disclosure. The example of FIG. 3A will be described with respect to a generic computing device, which may for example correspond to any of avionics 600, EFB 500, FMS cloud services platform 120, or another such device that may be used for securely receiving and transmitting flight plans to other devices.

In the example of FIG. 3A, the computing device stores, in a memory, an active flight plan (302). The active flight plan may, for example, be a .RTE file, a .FPL file, or another such type of file. As shown in the examples above, the flight plan may include a plurality of parameters, with each parameter having a value related to a flight.

The computing device transforms the active flight plan to determine a transformed flight plan that is different than the active flight plan (304). As explained above, the computing device may employ a transformation algorithm to convert the active flight plan into the transformed flight plan. The computing device may, for example, analyze key parameters of the active flight plan, such as waypoints, fuel requirements, estimated time of arrival, and destination region. The transformation algorithm may add, remove, or rename waypoints to create a transformed flight plan that appears legitimate but differs from the actual flight plan. The transformed flight plan may closely resemble a genuine flight plan, ensuring that unauthorized interceptors perceive the transformed flight plan as authentic. The transformation algorithm may, for example, add, remove, or rename waypoints or alter other data in the flight plan such as locations, times, or amounts. Additionally or alternatively, the transformation algorithm may change a first value for a flight parameter into a second value for the flight parameter. The flight parameter may be any of an amount of fuel (e.g., a total fuel, a trip fuel, or a reserve fuel), a time (e.g., an estimated time of departure, estimated time of arrival, estimated flight duration, or other such time value), a distance (e.g., a segment distance or total distance), or any other such parameter value.

The computing device stores, in the memory, the transformed flight plan (306) but does not actively process the transformed flight plan. That is, the computing device does not utilize the transformed flight plan for flight control, analytics, display, or any other such purpose. Instead of the transformed flight plan, the computing device processes the active flight plan (308). For example, if the computing device is an FMS, then the computing device may control an aircraft based on the active flight plan. If the computing device is a cloud services platform, then the computing devices may perform analytics on the active flight plan. If the computing device is an EFB, then the computing device may use the active flight plan for any of the various applications of the EFB.

In response to receiving commands or requests to transfer the active flight plan, the computing device instead transmits the transformed flight plan (310). That is, rather than transmitting the active flight plan, the computing device transmits the transformed flight plan. FIG. 3B describes the process of receiving the transformed flight plan. The computing device may, for example, transmit the transformed flight plan in response to receiving a request from an external device or receiving a command from a user of the computing device or an application running on the first device.

In response to determining that the active flight plan needs to be updated (312, Yes), the computing device stores, in the memory, the updated active flight plan (302) and processes the updated active flight plan (308). The computing device also transforms the updated active flight plan (304), stores an updated transformed flight plan (306), and uses the updated transformed flight plan for any transmissions (310). In the absence of any requests or commands to update the active flight plan, the computing device maintains the active flight plan and the transformed flight plan in their present form.

FIG. 3B is a flow diagram illustrating a data transfer process in accordance with the techniques of this disclosure. More specifically, FIG. 3B shows a process for receiving a transformed flight plan as transmitted by the computing device of FIG. 3A at step 310. The example of FIG. 3B will be described with respect to a second generic computing device with the computing device of FIG. 3A being a first computing device. The second computing device of FIG. 3B may, for example correspond to any of avionics 600, EFB 500, or FMS cloud services platform 120. The second generic computing device of FIG. 3B may be a device in communication with the first computing device of FIG. 3A.

In the example of FIG. 3B, the second computing device receives the transformed flight plan (320). In the example of FIG. 3B, the second computing device is an authorized device and, therefore, recognizes that the received flight plan is a transformed flight plan rather than an active flight plan. Accordingly, the second computing device determines a transform scheme used for the transformed flight plan (322). The second computing device may either implicitly derive the transform scheme used or may receive an explicit indication of the transform scheme used. The second computing device transforms the transformed flight plan into an actual flight plan using the transform scheme (324).

The second computing device may apply an inverse transform of the transform applied by the first computing device at step 304 of FIG. 3A. For example, if the first computing device added waypoints, then the second computing device may remove the added waypoints, or if the first computing device changed a value from a first value to a second value, then the second computing device may change the second value back to the first value. As another example, if the first computing device changed a first value for a flight parameter into a second value for the flight parameter, then the second computing device changes the second value for the flight parameter back to the first value for the flight parameter.

The second computing device processes the actual flight plan (326). For example, if the second computing device is an FMS, then the second computing device may control an aircraft based on the active flight plan. If the second computing device is a cloud services platform, then the second computing device may perform analytics on the active flight plan. If the second computing device is an EFB, then the second computing device may use the active flight plan for any of the various applications of the EFB.

The details of this disclosure have been described using several examples with respect to specific parameters being obfuscated in a specific manner. It should be understood, however, that the various obfuscation techniques described herein may be applied to any parameter or combination of parameters in a flight plan. Some transform schemes may obfuscate different parameters using different obfuscation techniques, and some transform schemes may obfuscated different instances of a similar parameter using different obfuscation techniques. In any given transform scheme, some parameters may maintain original values and not be obfuscated.

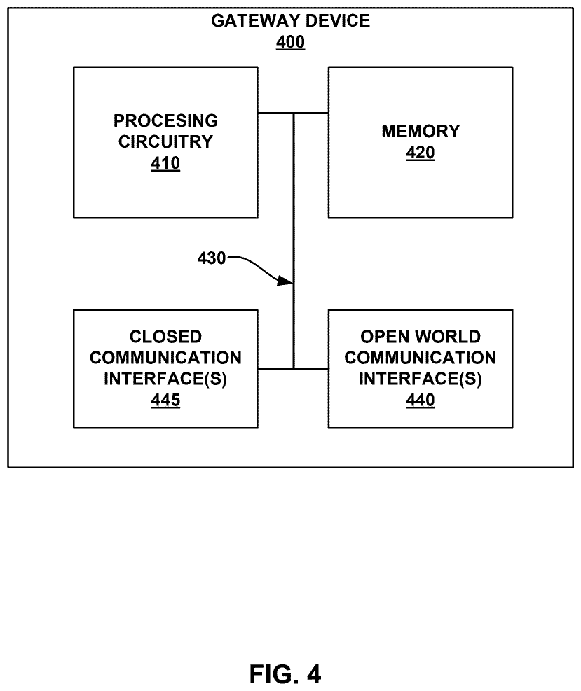

FIG. 4 illustrates an example of gateway device 400. Although this disclosure presents gateway device 400 as being separate from avionics 600, in many implementations, gateway device 400 may be a component of avionics 600 or otherwise highly integrated with avionics 600. Gateway device 400 may, for example, be a subsystem of avionics 600 that is configured to transmit and receive data from open world sources over internet-based or other open world communications protocols, whereas other subsystems of avionics 600 are restricted from, or otherwise not capable of, communicating with open world sources. In this regard, gateway device 400 generally represents a boundary between proprietary functions of the avionics and computing systems external to avionics 600.

Gateway device 400 may be configured to facilitate communication between EFB 500 and avionics 600. In the example of FIG. 4, gateway device 400 includes processing circuitry 410, memory 420, open world communication interface(s) 440, closed communication interface(s) 445. The aforementioned components of gateway device 400 may be connected to one another through a bus 430, which generally represents one or more busses and is intended to generically represent all the electrical and data connectivity of internal components included within gateway device 400.

Processing circuitry 410 implements the functionality of and/or executes the instructions associated with facilitating communication between EFB 500 and avionics 600. Processing circuitry 410 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, gateway device 400 may store instructions for the software in a suitable, non-transitory computer-readable medium (e.g., memory 420) and execute the instructions in hardware using processing circuitry 410 to perform the techniques of this disclosure.

Memory 420 is intended to generically represent all memory included within EFB 500. In some implementations, memory 420 may include a plurality of separate devices and memory units. Theses memory devices and memory units may include volatile memory, such as random access memory (RAM), and/or non-volatile memory, such as ROM and storage media. Example of RAM include dynamic random access memory (DRAM), including synchronous DRAM (SDRAM), magnetoresistive RAM (MRAM), resistive RAM (RRAM). Examples of storage media include solid-state storage media (e.g., solid state drives and/or removable flash memory), optical storage media (e.g., optical discs), and/or magnetic storage media (e.g., hard disk drives). The aforementioned encryption application (shown in FIG. 4 as encryption 422) may be stored in any volatile and/or non-volatile memory component of memory 420.

Gateway device 400 also includes open world communication interface(s) 440 for communicating with EFB 500 and closed communication interface(s) 445 for communicating with avionics 600. In this context, open world communication interface(s) 440 generally represents any hardware for communicating via open world protocols. Open world protocols are generally considered to be protocols that are publicly available and usually standardized. Examples of open world protocols include a transmission control protocol/internet protocol (TCP/IP), a hypertext transfer protocol/secure (HTTP/HTTPS), a file transfer protocol (FTP), a secure FTP, a web socket, a constrained application protocol (CoAP), Bluetooth, ZigBee, a network file system (NFS), or the like.

Closed communication interface(s) 445 generally represents any hardware for communicating via closed protocols. In this context, a closed protocol generally refers to a protocol that is proprietary or vendor specific and for which the specifications are not publicly disclosed. A closed protocol is typically intended to limit access to specific vendors or products rather than to grant public access. Closed communication interface(s) 445 may, for example, include a secured bus for communicating directly with avionics 600.

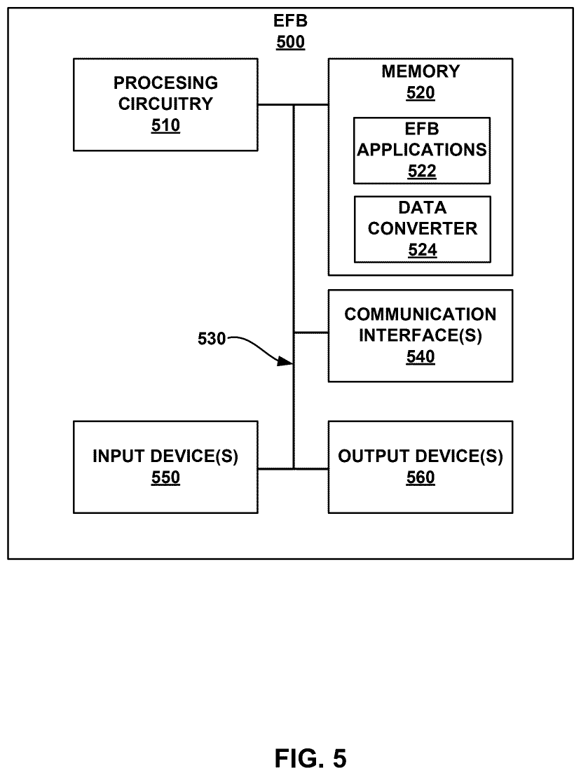

FIG. 5 illustrates an example of EFB 500. EFB 500 may be any sort of generic computing hardware, such as a tablet computer, phone, laptop computer, desktop computer, or other such computing device, that is configured to store and execute EFB applications. In other examples, EFB 500 may be specialized computing hardware configured to store and execute EFB applications. Some EFBs may be portable and be able to be carried from plane to plane, while other EFBs may be permanently mounted in a specific airplane. In the example of FIG. 5, EFB 500 includes processing circuitry 510, memory 520 which stores EFB applications 522 and data converter 524, and communication interface(s) 540 to communicate with other devices, such as gateway device 400.

Processing circuitry 510 implements the functionality of and/or executes the instructions associated with EFB applications 522. Processing circuitry 510 may be implemented as any of a variety of suitable circuitry that includes a processing system, such as one or more integrated circuits, microprocessors, DSPs, ASICs, FPGAs, discrete logic, software, hardware, firmware or any combinations thereof. When the techniques are implemented partially in software, EFB 500 may store instructions for the software in a suitable, non-transitory computer-readable medium (e.g., memory 520) and execute the instructions in hardware using processing circuitry 510 to perform the techniques of this disclosure.

Memory 520 is intended to generically represent all memory included within EFB 500. In some implementations, memory 520 may include a plurality of separate devices and memory units. Theses memory devices and memory units may include volatile memory, such as RAM), and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned EFB application (shown in FIG. 5 as EFB applications 522) may be stored in any volatile and/or non-volatile memory component of memory 520.

EFB 500 also includes input device(s) 550 (e.g., a keyboard, mouse, or touchscreen) and output device(s) 560 (e.g., a display, printer). In implementations where EFB 500 is a phone or tablet computer, then the EFB may, for example, have a touchscreen and a display. In implementations where EFB 500 is a larger computer device, then the EFB may, for example, have a mouse, trackpad, keyboard, or other such input devices. The aforementioned components of EFB 500 may be connected to one another through a bus 530, which generally represents one or more busses and is intended to generically represent all the electrical and data connectivity of internal components included within EFB 500.

Communication interface(s) 540 generally represents all hardware, e.g., transceiver circuitry, within EFB 500 for communicating with external devices. Communication interface(s) 540 may facilitate communication with external devices via one or more wired and/or wireless network connections by transmitting and/or receiving signals on the one or more networks. Examples of communication interface(s) 540 include a network interface card (e.g., such as an Ethernet card), an optical transceiver, a radio frequency transceiver, a GPS receiver, or any other type of device that can send and/or receive information. Other examples of communication interface(s) 344 may include short wave radios, cellular data radios, wireless network radios, as well as universal serial bus (USB) controllers. In some examples, communication interface(s) 344 may include an avionics full-duplex switched ethernet (AFDX) interface, also known as ARINC 664.

EFB applications 522 represent a suite of software tools that may be used by a pilot in managing flight operations. EFB applications 522 may include flight planning applications that allow pilots to create and file flight plans, access weather information, and calculate fuel requirements. EFB applications 522 may also include navigation applications that provide real-time navigation support with maps, airspace information, and waypoint management. EFB applications 522 may also include weather applications that provide real-time weather data, future weather predictions, radar imagery, and the like. EFB applications 522 may also include checklist applications for ensuring compliance with pre-flight, mid-flight, and post-flight procedures. EFB applications 522 may also include various performance analysis tools that, for example, help pilots compute takeoff and landing distances based on current conditions and aircraft configuration. EFB applications 522 may also include aircraft maintenance tracking tools that track aircraft maintenance schedules, inspection records, and compliance records. EFB applications 522 may may also include flight logbooks that enable pilots to log flights, track hours, and generate reports for currency and certification. EFB applications 522 may also include airport information applications that provide information about airports, including runway layouts, services, and notices.

The various example applications listed above represent a non-exhaustive list of the types of applications that may be included in EFB applications 522. As explained above, some applications of EFB applications 522 may facilitate communication with avionics 600 using the data communication techniques of this disclosure.

EFB 500 may be configured to communicate a flight plan for an aircraft to an FMS or receive a flight plan from an FMS in accordance with the techniques of this disclosure. EFB 500 may, for example, store, in memory 520, both an active flight plan and a transformed flight plan. In response to receiving an update to the active flight plan, processing circuitry 510 may make the update to the active flight plan and, using a transform scheme of data converter 524, make a corresponding update to the transformed flight plan. EFB applications 522 may use the active flight plan for navigation, flight planning, performance analysis, and the like. In response to a request or command to transmit a copy of the active flight plan, processing circuitry 510 may instead transmit, via communication interface(s) 540, a copy of the transformed flight plan.

EFB 500 may also be configured to receive, via communication interface(s) 540, a copy of the transformed flight plan from another device such as avionics 600 or FMS cloud services platform 120. In response to receiving the transformed flight plan, processing circuitry 510 may determine a transform scheme from the transform schemes of data converter 524 used for the transformed flight plan, transform the transformed flight plan into an actual flight plan, and process the actual flight plan.

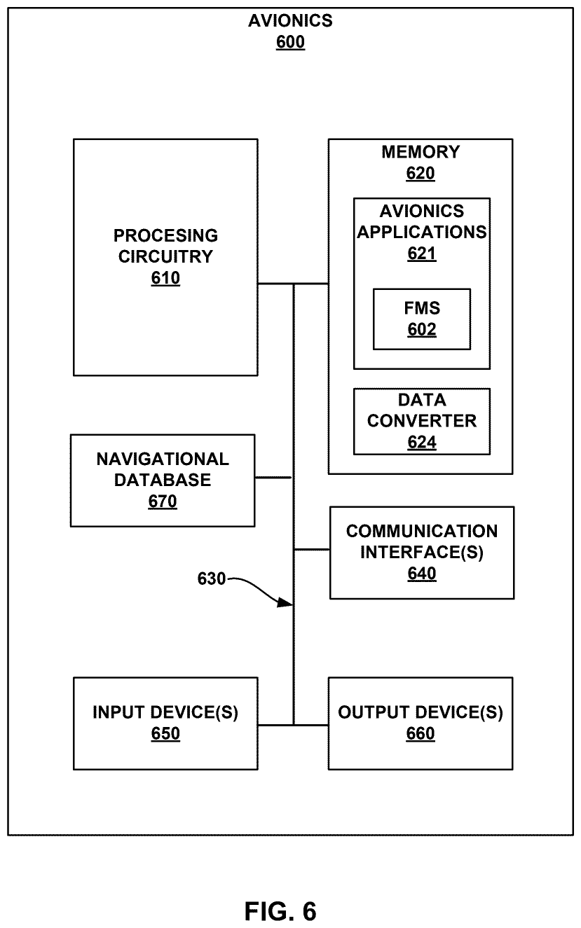

FIG. 6 illustrates an example of avionic 600. Avionics 600 is specialized computing hardware configured to store and execute avionics applications. In the example of FIG. 6, avionics 600 includes processing circuitry 610, memory 620 which stores avionics applications 621, communication interface(s) 640 to communicate with other devices, such as gateway device 400, input device(s) 650, output device(s) 660, and navigational database 670. The aforementioned components of avionics 600 may be connected to one another through a bus 630, which generally represents one or more busses and is intended to generically represent all the electrical and data connectivity of internal components included within avionics 600.

Processing circuitry 610 implements the functionality of and/or executes the instructions associated with avionics applications 621. Processing circuitry 610 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, avionics 600 may store instructions for the software in a suitable, non-transitory computer-readable medium (e.g., memory 620) and execute the instructions in hardware using processing circuitry 610 to perform the techniques of this disclosure.

Memory 620 is intended to generically represent all memory included within avionics 600. In some implementations, memory 620 may include a plurality of separate devices and memory units. Theses memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 6 as avionics applications 621) may be stored in any volatile and/or non-volatile memory component of memory 620.

Communication interface(s) 640 generally represents all hardware, e.g., transceiver circuitry, within avionics 600 for communicating with external devices either on the ground or while in flight. Communication interface(s) 640 may facilitate communication with external devices via one or more wired and/or wireless network connections by transmitting and/or receiving signals on the one or more networks. Examples of communication interface(s) 540 include a network interface card (e.g., such as an Ethernet card), an optical transceiver, a radio frequency transceiver, a GPS receiver, or any other type of device that can send and/or receive information. Other examples of communication interface(s) 640 may include short wave radios, cellular data radios, wireless network radios, as well as universal serial bus (USB) controllers. Examples of communication interface(s) 640 for in-flight communication include a very high frequency (VHF) radio, a high frequency (HF) radio, or a satellite communication (SATCOM) radio. Examples of communication interface(s) 640 used for data links include an aircraft communications addressing and reporting system (ACARS) for providing a digital data link system that allows for the exchange of messages between the aircraft and ground stations for purposes such as flight plan updates, weather information, and maintenance reports. Another examples of communication interface(s) 640 used for data links include controller-pilot data link communications (CPDLC) which allows air traffic control to send instructions and receive acknowledgments from pilots via text messages. Communications interface(s) 640 may also include an automatic dependent surveillance-broadcast transponder. The various examples of communications interfaces listed above represent a non-exhaustive list of the types of the types of communication interfaces that may be included in communication interface(s) 640.

Avionics 600 also includes input device(s) 650 and output device(s) 660. Examples of input device(s) 650 include control display units (CDUs) with alphanumeric keypads or touchscreens to enter flight plans, waypoints, and other necessary data. Input device(s) 650 may also include an FMS control panel for entering information to the FMS, such as route, altitude, and speed using dedicated buttons, knobs, and touchscreen interfaces. Input device(s) 650 may also include yoke or sidestick controls as well as touchscreen interfaces. Input device(s) 650 may also include rotary knobs for setting values for altitudes, speeds, and other parameters and toggle switches for selecting modes or turning systems on and off.

Examples of output device(s) 660 may include an electronic flight instrument display to provide visual representations of flight data, including altitude, airspeed, heading, and attitude. Output device(s) 560 may also include a Heads-Up Display (HUD) that projects critical flight information onto a transparent screen in the pilot's line of sight or other cockpit displays to show navigation maps, engine parameters, system statuses, and the like. Output device(s) 560 may also include engine instrumentation displays to display data on engine performance, such as temperature, pressure, and revolutions per minute (RPMs). Output device(s) 560 may also include audio panels to relay communication from radios and alerts from systems to the cockpit. Output device(s) 560 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of the types of input and output devices that may be included in input device(s) 650 and output device(s) 660. Additionally, input and output functionality of avionics 600 may facilitated by external devices that are separate from input device(s) 650 and output device(s) 660. For example, EFB 500 may be configured to input data to and output data for avionics 600.

Avionics applications 621 represent a suite of software tools that may be used by a pilot in managing flight operations. Avionics applications 621 includes FMS 602 discussed above as well as other applications for communication, navigation, and monitoring within an aircraft.

Navigational database 670 represents a specialized database that stores information needed by FMS 602 for the navigation and operation of an aircraft for purposes such as flight planning, route management, and ensuring safe navigation throughout a flight. Navigational database 670 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 670 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 670 may be regularly updated to reflect changes in air traffic regulations, airport information, and navigational aids to ensure pilots have current information for safe and efficient flight operations.

Although not explicitly shown in FIG. 6, avionics 600 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 600 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Avionics 600 may be configured to communicate a flight plan for an aircraft to an EFB or receive a flight plan from an EFB in accordance with the techniques of this disclosure. Avionics 600 may, for example, store, in memory 620, both an active flight plan and a transformed flight plan. In response to receiving an update to the active flight plan, processing circuitry 610 may make the update to the active flight plan and, using a transform scheme selected from multiple transform schemes supposed by data converter 624, make a corresponding update to the transformed flight plan. FMS 602 may use the active flight plan for controlling the aircraft. In response to a request or command to transmit a copy of the active flight plan, processing circuitry 610 may instead transmit, via communication interface(s) 640, a copy of the transformed flight plan.

Avionics 600 may also be configured to receive, via communication interface(s) 640, a copy of the transformed flight plan from another device such as EFB 500 or FMS cloud services platform 120. In response to receiving the transformed flight plan, processing circuitry 610 may determine a transform scheme from the plurality of transform schemes supported by data converter 624 used for the transformed flight plan, transform the transformed flight plan into an actual flight plan, and process the actual flight plan.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A computer-implemented method for communicating a flight plan from avionics of an aircraft to a computing device, the method comprising:
storing, in a memory of the avionics, an active flight plan;
storing, in the memory of the avionics, a transformed flight plan that is different than the active flight plan;
in response to receiving an update to the active flight plan:
making the update to the active flight plan; and
making a corresponding update to the transformed flight plan based on a transform scheme that transforms the active flight plan to the transformed flight plan;
controlling, by processing circuitry of the avionics, a flight management system based on the active flight plan, wherein the flight management system controls an aircraft to follow a flight path defined by the active flight plan; and
transmitting to the computing device a copy of the transformed flight plan.

2. The method of claim 1, wherein the active flight plan comprises a first file storing a first series of waypoints and the transformed flight plan comprises a second file storing a second series of waypoints that are different than the first series of waypoints.

3. The method of claim 1, further comprising:
determining the transform scheme based on a value included in the active flight plan.

4. The method of claim 1, wherein transmitting the copy of the transformed flight plan comprises encrypting the copy of the transformed flight plan.

5. The method of claim 1, wherein transmitting the copy of the transformed flight plan comprises transmitting the copy of the transformed flight plan using a hypertext transfer protocol (HTTP).

6. The method of claim 1, wherein transmitting to the computing device the copy of the transformed flight plan comprises transmitting to the computing device the copy of the transformed flight plan in response to receiving a request or a command for the active flight plan.

7. The method of claim 1, further comprising:
selecting the transform scheme from a plurality of available transform schemes based on a value of a parameter in the active flight plan.

8. The method of claim 1, further comprising:
selecting the transform scheme from a plurality of available transform schemes based on a user input received at the flight management system.

9. A first computing device for communicating a flight plan for an aircraft to a second computing device, the first computing device comprising:
transceiver circuitry;
a memory configured to store an active flight plan and a transformed flight plan that is different than the active flight plan; and
processing circuitry configured to:
in response to receiving an update to the active flight plan:
make the update to the active flight plan; and
make a corresponding update to the transformed flight plan based on a transform scheme that transforms the active flight plan to the transformed flight plan;
process the active flight plan in one or more applications being executed by the processing circuitry; and
cause the transceiver circuitry to transmit to the second computing device a copy of the transformed flight plan.

10. The first computing device of claim 9, wherein the first computing device comprises avionics of the aircraft and the second computing device comprises a computing device external to the avionics of the aircraft.

11. The first computing device of claim 10, wherein the one or more applications being executed by the processing circuitry comprises a flight management system, and wherein to process the active flight plan in the one or more applications being executed by the processing circuitry, the processing circuitry causes the flight management system to control the aircraft to follow a flight path defined by the active flight plan.

12. The first computing device of claim 9, wherein the active flight plan comprises a first file storing a first series of waypoints and the transformed flight plan comprises a second file storing a second series of waypoints that are different than the first series of waypoints.

13. The first computing device of claim 9, wherein the active flight plan comprises a first file storing a first value for a flight parameter and the transformed flight plan comprises a second file storing a second value for the flight parameter.

14. The first computing device of claim 13, wherein the flight parameter comprises one of an amount of fuel, a time, or a distance.

15. The first computing device of claim 9, wherein to transmit the copy of the transformed flight plan, the processing circuitry is configured to cause the transceiver circuitry to transmit the copy of the transformed flight plan using a hypertext transfer protocol (HTTP).

16. The first computing device of claim 9, wherein to transmit the copy of the transformed flight plan, the processing circuitry is configured to cause the transceiver circuitry to transmit to the second computing device the copy of the transformed flight plan in response to receiving a request or command for the active flight plan.

17. The first computing device of claim 9, wherein the processing circuitry is further configured to:
select the transform scheme from a plurality of available transform schemes based on a value of a parameter in the active flight plan.

18. The first computing device of claim 9, wherein the first computing device comprises avionics of the aircraft, and the processing circuitry is further configured to:
select the transform scheme from a plurality of available transform schemes based on a user input received at the avionics.

19. The first computing device of claim 9, wherein the first computing device comprises an external computing device and the second computing device comprises avionics of the aircraft.

20. The first computing device of claim 9, wherein the second computing device comprises a cloud-based platform.
